(19) United States
(12) Patent Application Publication
(10) Pub. No.: US 2026/0337049 A1
(43) Pub. Date: Oct. 29, 2026

(54) LITHIUM GARNET AND METHODS OF MAKING THE SAME

(71) Applicant: CORNING INCORPORATED, CORNING, NY (US)

(72) Inventors: Bethany Rose Conway, Lindley, NY (US); Patrick David Tepesch, Corning, NY (US); Elizabeth Marie Vileno, Addison, NY (US)

(21) Appl. No.: 19/120,586

(22) PCT Filed: Oct. 10, 2023
(86) PCT No.: PCT/US2023/034774

§ 371 Date: Apr. 11, 2025

Related U.S. Application Data
(60) Provisional application No. 63/417,388, filed on Oct. 19, 2022.

(51) Int. Cl. C01G 25/02

(52) U.S. Cl. CPC C01G 25/02; C01P 2004/38

(57) ABSTRACT

Methods of making lithium garnet include combining a lithium source, a lanthanum source, a zirconium source, an optional dopant, and an optional lithium garnet seed crystal to form a precursor mixture. Methods include mixing the precursor mixture with a solvent to form a slurry. Methods include drying the slurry to form a solid precursor. Methods include calcining the solid precursor at a calcining temperature from about 900 °C to about 1200 °C for a period of time from about 2 minutes to about 40 minutes to form the lithium garnet. The lithium garnet can be formed into sintered sheets for use, for example, as electrodes or solid-state electrolytes.

This application claims the benefit of priority under 35 U.S.C. § 119 of U.S. Provisional Application Ser. No. 63/417,388 filed on Oct. 19, 2022, the content of which is relied upon and incorporated herein by reference in its entirety.

### FIELD

The present disclosure relates to lithium garnet and methods of making the same, and more particularly to lithium garnet formed by calcining for about 40 minutes or less and methods of making the same.

### BACKGROUND

Lithium garnet (e.g., lithium-stuffed garnet) can be used as an electrode (e.g., cathode, anode) and/or as a solid-state electrolyte in batteries, for example, solid-state batteries. It is known to form lithium garnet by calcining. However, methods can lose lithium during processing, which requires excess lithium to be added. Also, methods can require sintering for an extended period of time, for example, a day or more. Consequently, there is a need for new methods of forming lithium garnet that can be formed without excess lithium and/or in reduced time.

### SUMMARY

The present disclosure provides lithium garnet that can be made by calcining for about 40 minutes or less. Compared to traditional methods that can require a day or more of calcining, the methods of the present disclosure represent an unexpected and substantial reduction in processing time and associated costs. As discussed below with reference to FIG. 7, it is unexpected that 80% or more or 90% or more of a volume of the resulting lithium can be in a cubic phase with a calcining step at a temperature from about 900 °C to about 1200 °C for 40 minutes or less (e.g., within one or more of the ranges mentioned above in this paragraph). Without wishing to be bound by theory, the cubic phase of lithium garnet has a higher ionic conductivity than the tetragonal phase of lithium garnet.

Methods include forming slurry from a precursor mixture that can be dried to form a solid precursors, for example, a precursor cake that can comprise a plurality of naturally formed chunks. The naturally formed chunks can be physically stable such that they can be handled without disintegrating. Without wishing to be bound by theory, it is believed that the plurality of naturally formed chunks maintains a uniform distribution of source materials from the slurry, which enables the calcining to occur quickly, as compared to powders or non-physically stable materials that do not maintain the uniform distribution of source materials. In aspects, the lanthanum source can comprise lanthanum oxide that can react with the solvent (e.g., water) to form lanthanum hydroxide in step 105. The reaction from lanthanum oxide to lanthanum hydroxide can cause the lanthanum source to break into smaller particles, which decreases the overall particle size distribution of materials in the slurry.

During the calcining, a flow of a non-reactive gas can be provided and/or the solid precursor (e.g., precursor cake) can be placed on a surface that does not react with the lithium source. Without wishing to be bound by theory, providing the gas flow can increase the removal of any residual solvent and/or gases volatilized during the calcining, which can enable the calcining to be completed faster than would otherwise be possible. Providing a surface that does not react with the lithium source can enable the lithium garnet to be formed without excess lithium relative to the resulting stoichiometric ratio.

Some example aspects of the disclosure are described below with the understanding that any of the features of the various aspects may be used alone or in combination with one another.

Aspect 1. A method of making lithium garnet comprising:
combining a lithium source, a lanthanum source, a zirconium source, an optional dopant, and an optional lithium garnet seed crystal to form a precursor mixture;
mixing the precursor mixture with a solvent to form a slurry;
drying the slurry to form a solid precursor; and calcining the solid precursor at a calcining temperature from about 900 °C to about 1200 °C for a period of time from about 2 minutes to about 40 minutes to form the lithium garnet.

Aspect 2. The method of aspect 1, wherein one or none of the materials in the precursor mixture has a solubility in the solvent of 15 grams per liter or more.

Aspect 3. The method of any one of aspects 1-2, wherein one or both of the lithium source or the zirconium source do not react prior to the calcining.

Aspect 4. The method of any one of aspects 1-3, wherein the precursor mixture comprises the lithium garnet seed crystal in an amount from about 0.1 wt % to about 1 wt % of the precursor mixture.

Aspect 5. The method of any one of aspects 1-4, wherein the precursor mixture is stoichiometric to a composition of the lithium garnet.

Aspect 6. The method of any one of aspects 1-4, wherein the lithium garnet comprises a composition comprising:
(i) Li₇₋₃ₐLa₃Zr₂LₐO₁₂, with L=Al, Ga, or Fe and 0<a<0.33;
(ii) Li₇La_{3-b}Zr₂M_{b}O₁₂, with M=Bi or Y and 0<b<1;
(iii) Li_{7-c}La₃(Zr_{2-c},N_{c})O₁₂, with N=In, Si, Ge, Sn, V, W, Te, Nb, or Ta and 0<c<1;
(iv) protonated LLZO (e.g., HₓLi_{6.5-x}La₃Zr_{1.5}I_{0.5}O₁₂, with I=In, Si, Ge, Sn, V, W, Te, Nb, or Ta and 0<x<4 or HₓLi_{6.25-x}E_{0.25}La₃Zr₂O₁₂, with E=Al, Ga, or Fe and 0<x<4); or
a combination thereof,
wherein the optional dopant comprises L, M, N, I, or E.

Aspect 7. The method of any one of aspects 1-6, wherein from about 80% to about 95% of a volume of the lithium garnet comprises a cubic phase.

Aspect 8. The method of any one of aspects 1-6, wherein 90% or more of a volume of the lithium garnet comprising a cubic phase.

Aspect 9. The method of any one of aspects 1-8, wherein the mixing comprises milling the precursor mixture with the solvent for about 90 minutes or more.

Aspect 10. The method of any one of aspects 1-9, wherein the drying comprises heating the slurry at from about 100 °C to about 150 °C for from about 30 minutes to about 2 hours.

Aspect 11. The method of any one of aspects 1-10, wherein the solid precursor comprises a precursor cake comprising a plurality of naturally formed chunks.

Aspect 12. The method of any one of aspects 1-11, wherein the period of time is from about 4 minutes to about 30 minutes.

Aspect 13. The method of aspect 12, wherein the period of time is from about 4 minutes to about 12 minutes.

Aspect 14. The method of any one of aspects 1-13, wherein the solid precursor is heated at a temperature increasing from an initial temperature from about 20 °C to about 30 °C to the calcining temperature over a second period of time from about 2 minutes to about 15 minutes.

Aspect 15. The method of any one of aspects 1-14, wherein the calcining further comprising flowing a non-reactive gas over the solid precursor.

Aspect 16. The method of any one of aspects 1-15, wherein the solvent comprises water.

Aspect 17. The method of any one of aspects 1-16, wherein the lanthanum source is lanthanum oxide, and during the mixing, at least a portion of the lanthanum oxide forms lanthanum hydroxide.

Aspect 18. The method of any one of aspects 1-16, wherein:
the precursor mixture consisting of the lithium source, the lanthanum source, the zirconium source, the optional dopant, and the lithium garnet seed crystal; and
the slurry consists of the solvent, the lithium source, the zirconium source, the optional dopant, the lithium garnet seed crystal, and either the lanthanum source or lanthanum hydroxide.

Aspect 19. The method of any one of aspects 1-18, wherein the lithium source comprises lithium carbonate, and the zirconium source comprises zirconia.

Aspect 20. The method of any one of aspects 1-19, wherein the solid precursor is placed on a surface that does not react with the lithium source during the calcining.

Aspect 21. The method of any one of claims 1-20, wherein the calcining temperature is in a range from about 950 °C to about 1100 °C.

### BRIEF DESCRIPTION OF THE DRAWINGS

The above and other features and advantages of aspects of the present disclosure are better understood when the following detailed description is read with reference to the accompanying drawings, in which:

FIG. 1 is a flow chart illustrating example methods of forming lithium garnet in accordance with aspects of the disclosure;

FIG. 2 schematically illustrates mixing a precursor mixture with a solvent to form a slurry;

FIG. 3 illustrates drying the slurry to form a solid precursor;

FIG. 4 illustrates view 4-4 of FIG. 3;

FIG. 5 illustrates calcining the solid precursor to form the lithium garnet;

FIG. 6 illustrates a sintered sheet comprising lithium garnet;

FIG. 7 illustrates a volume percentage of cubic phase garnet as a function of calcining conditions in accordance with aspects of the disclosure;

FIG. 8 illustrates particle size distributions for precursor materials; and

FIG. 9 illustrates particle size distributions for lithium garnet in accordance with aspects of the disclosure.

Throughout the disclosure, the drawings are used to emphasize certain aspects. As such, it should not be assumed that the relative size of different regions, portions, and substrates shown in the drawings are proportional to its actual relative size, unless explicitly indicated otherwise.

### DETAILED DESCRIPTION

Aspects will now be described more fully hereinafter with reference to the accompanying drawings in which example aspects are shown. Whenever possible, the same reference numerals are used throughout the drawings to refer to the same or like parts.

FIG. 6 illustrates a sintered sheet 601 comprising a lithium garnet formed from the lithium garnet 607 made in accordance with aspects of the disclosure. Unless otherwise noted, a discussion of features in one aspect can apply equally to corresponding features of any aspect of the disclosure. For example, identical part numbers throughout the disclosure can indicate that, in some aspects, the identified features are identical to one another and that the discussion of the identified feature of one aspect, unless otherwise noted, can apply equally to the identified feature of any of the other aspects of the disclosure.

FIG. 6 illustrates the sintered sheet 601 comprising a first major surface 605 and a second major surface 607 opposite the first major surface 605. In aspects, the first major surface 605 and/or the second major surface 607 can extend along a corresponding plane, and/or the first major surface 605 can be substantially parallel to the second major surface 607. A sheet thickness 609 of the sintered sheet 601 is defined as an average distance between the first major surface 605 and the second major surface 607. In aspects, the sheet thickness 609 can be about 5 micrometers (μm) or more, about 10 μm or more, about 15 μm or more, about 20 μm or more, about 100 μm or less, about 70 μm or less, about 50 μm or less, or about 30 μm or less. In aspects, the sheet thickness 609 can range from about 5 μm to about 100 μm, from about 10 μm to about 70 μm, from about 15 μm to about 50 μm, from about 20 μm to about 30 μm, or any range or subrange therebetween.

In aspects, the lithium garnet 607 can comprise a composition comprising, for example, at least one of: (i) Li₇₋₃ₐLa₃Zr₂LₐO₁₂, with L=Al, Ga or Fe and 0<a<0.33; (ii) Li₇La_{3-b}Zr₂M_{b}O₁₂, with M=Bi or Y and 0<b<1; (iii) Li_{7-c}La₃(Zr_{2-c},N_{c})O₁₂, with N=In, Si, Ge, Sn, V, W, Te, Nb, or Ta and 0<c<1; (iv) protonated LLZO (e.g., HₓLi_{6.5-x}La₃Zr_{1.5}I_{0.5}O₁₂, with I=In, Si, Ge, Sn, V, W, Te, Nb, or Ta and 0<x<4 or HₓLi_{6.25-x}E_{0.25}La₃Zr₂O₁₂, with E=Al, Ga or Fe and 0<x<4), or a combination thereof. In aspects, the sintered sheet 601 can function as an electrode or a solid-state electrolyte in a battery (e.g., solid-state battery). Applicants note that elements such as Si, Ge, In, and Sn may have multiple oxidation states, including 5+, but that 5+ valence of elements may have a significant population, such as in a garnet or other material disclosed herein.

Throughout the disclosure, a “particle size” of a ceramic particle is determined from direct imaging with a scanning electron microscope (SEM), where the largest dimension of the ceramic particle is taken as the particle size. In aspects, a median particle size of the lithium garnet (e.g., in the sintered sheet) can be about 5 μm or less, about 2 μm or less, about 1 μm or less, about 0.8 μm or less, or about 0.5 μm or less, for example, ranging from 0.01 μm to about 5 μm, from about 0.05 μm to about 2 μm, from about 0.1 μm to about 1 μm, from about 0.2 μm to about 0.8, from about 0.3 μm to about 0.5 μm, or any range or subrange therebetween.

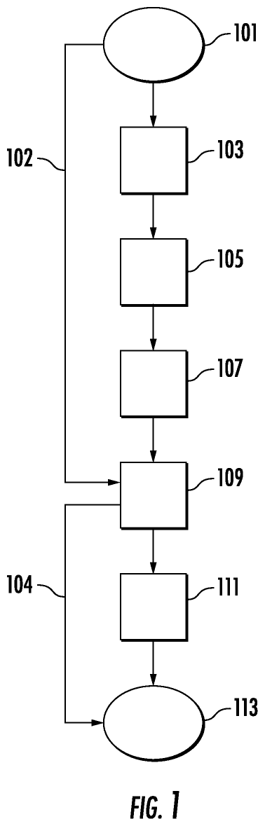

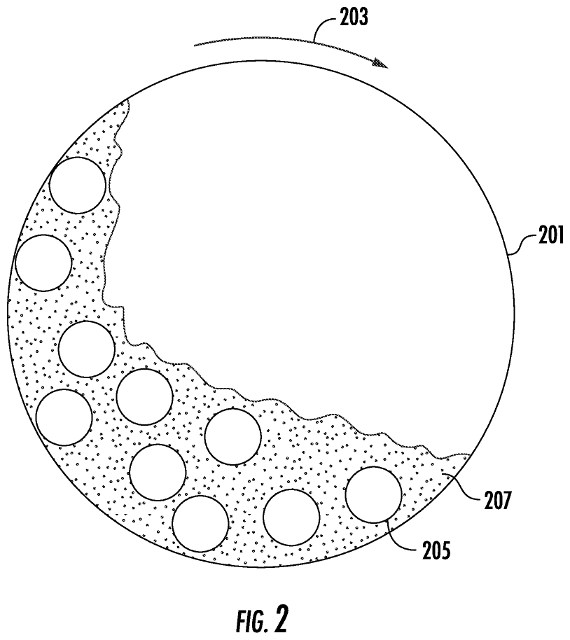

Aspects of methods of making lithium garnet (e.g., sintered sheet comprising lithium garnet) in accordance with aspects of the disclosure will be discussed with reference to the flow chart in FIG. 1 and example method steps illustrated in FIGS. 2-5. In a first step 101, methods can start with obtaining a lithium source, a lanthanum source, a zirconium source, an optional dopant, and an optional lithium garnet seed crystal. In aspects, the lithium source can be lithium carbonate. In aspects, the lanthanum source can be lanthanum oxide or lanthanum hydroxide. In aspects, the zirconium source can be zirconia or zirconium(IV) hydroxide. Exemplary aspects of the lithium source and the zirconium source are lithium carbonate and zirconia, respectively. In aspects, the lithium garnet seed crystal can comprise or more of the compositions discussed above for the lithium garnet 607. In further aspects, the lithium garnet seed crystal can be in a cubic crystal phase. In aspects, the optional dopant can comprise aluminum (Al), bismuth (Bi), calcium (Ca), gallium (Ga), germanium (Ge), indium (In), iron (Fe), magnesium (Mg) niobium (Nb), silicon (Si), strontium (Sr), tantalum (Ta), tellurium (Te), tin (Sn), tungsten (W), vanadium (V), yttrium (Y), or combinations thereof. In further aspects, the optional dopant can be in the form of an oxide. In further aspects, the optional dopant can be combined with one or more of the sources (e.g., yttrium-stabilized zirconium, zircon). In aspects, the lithium source, the lanthanum source, the zirconium source, and the seed crystal are all separate and distinct materials. The lithium source, the lanthanum source, the zirconium source, the optional dopant, and/or the lithium garnet seed can be obtained by purchase or by making the material. For example, the lithium garnet seed can be taken from the result of a prior method of making lithium garnet.

After step 101, methods can proceed to step 103 comprising combining the lithium source, the lanthanum source, the zirconium source, the optional dopant, and the lithium garnet seed crystal to form a precursor mixture. In aspects, the precursor mixture can consist of the lithium source, the lanthanum source, the zirconium source, the optional dopant, and the lithium garnet seed crystal. As discussed above, the lithium source, the lanthanum source, the zirconium source, and the seed crystal in the precursor mixture can all be separate and distinct materials. In aspects, the precursor mixture can comprise the source materials (e.g., the lithium source, the lanthanum source, the zirconium source, and the optional dopant) in a stoichiometric ratio corresponding to one or more of the compositions discussed above for the lithium garnet 607. In aspects, the precursor mixture can comprise the source materials (e.g., the lithium source, the lanthanum source, the zirconium source, and the optional dopant) in a stoichiometric ratio corresponding to the lithium garnet seed crystal and/or the resulting lithium garnet formed in the method. For example, the precursor mixture can have less than 2%, less than 1%, less than 0.5%, or no excess lithium relative to one or more of the stoichiometric ratios mentioned above in this paragraph. In aspects, the lithium garnet seed crystal, as a weight % (wt %) of the precursor mixture, can be about 0.10% or more, about 0.2% or more, about 0.3% or more, about 10% or less, about 0.8% or less, or about 0.6% or less, for example, from about 0.1% to about 1%, from about 0.2% to about 0.8%, from about 0.3% to about 0.6%, or any range or subrange therebetween. In aspects, mixing to form the precursor mixture can comprise mixing for about 2 minutes or more, about 5 minutes or more, or about 10 minutes or more, for example, from about 2 minutes to about 16 hours, from about 5 minutes to about 4 hours, from about 10 minutes to about 1 hour, from about 10 minutes to about 30 minutes, or any range or subrange therebetween.

After step 103, as shown in FIG. 2, methods can proceed to step 105 comprising mixing the precursor mixture with a solvent to form a slurry. In aspects, as shown in FIG. 2, mixing (as indicated by arrow 203) the precursor mixture can form a slurry 207 in a mixer 201. For example, as shown, the precursor mixture and the solvent can be mixed by milling with milling media 205, for example, attribution milling or ball milling, although other methods such as plow milling are possible. In aspects, the solvent added to the precursor mixture, as a wt % of the precursor mixture, can be about 30% or more, about 40% or more, about 50% or more, about 100% or less, about 80% or less, or about 70% or less. In aspects, the solvent added to the precursor mixture, as a wt % of the precursor mixture, can range from about 30% to about 100%, from about 40% to about 80%, from about 50% to about 70%, or any range or subrange therebetween. In aspects, the solvent can be a protic solvent, although any solvent satisfying the solubility or insolubility aspects discussed in the next paragraph could be used in other aspects. An exemplary aspect of the solvent is water. As used herein, “solvent” refers to a material that is liquid at 25 °C and is not one of the material sources (e.g., lithium source, lanthanum source, zirconium source, optional dopant) that is present in the resulting lithium garnet. In aspects, the solvent (e.g., in step 105 or throughout a method) can consist of a single material (e.g., water). In aspects, the mixing in step 105 can be at least 90 minutes or more. In further aspects, the mixing in step 105 can be about 90 minutes or more, about 105 minutes or more, about 120 minutes or more, about 24 hours or less, about 8 hours or less, about 4 hours or less, or about 3 hours or less, for example, in a range from about 90 minutes to about 24 hours, from about 105 minutes to about 8 hours, from about 120 minutes to about 4 hours, from about 120 minutes to about 3 hours, or any range or subrange therebetween.

As used herein, solubility in a solvent is measured at 25 °C in accordance with ASTM E1148-02. Unless specified otherwise, a material is considered “insoluble” in a solvent if it has a solubility of 15 grams per 1 liter of the solvent (g/L). For example, lithium carbonate is insoluble in water because it has a solubility at 25 °C of 12.9 g/L in water, which is less than 15 g/L. Likewise, zirconia is insoluble in water because it has negligible solubility in water at 25 °C. In aspects, none of the materials or one of the materials in the precursor mixture can have a solubility of greater than 15 g/L in the solvent and/or water. In aspects, all or all but one of the materials in the precursor mixture can be insoluble in the solvent and/or water. Since one or fewer materials have a solubility of greater than 15 g/L in the solvent and/or all or all but one material is insoluble in the solvent, there may be no reaction between the source materials (e.g., lithium source, zirconium source, optional dopant, lanthanum source) may occur in step 105. Consequently, one or both of the lithium source or the zirconium source may not react prior to the calcining in step 109. In aspects, the lanthanum source can comprise lanthanum oxide that can react with the solvent (e.g., water) to form lanthanum hydroxide in step 105. The reaction from lanthanum oxide to lanthanum hydroxide can cause the lanthanum source to break into smaller particles, which decreases the overall particle size distribution of materials in the slurry. In aspects, step 105 can include controlling a temperature of the slurry, for example, through heat exchange with a cooling fluid since the reaction from lanthanum oxide to lanthanum hydroxide is exothermic (i.e., releases heat). Consequently, in further aspects, the slurry can consist of the solvent, the lithium source, the zirconium source, the optional dopant, the lithium garnet seed crystal, and either the lanthanum source or lanthanum hydroxide.

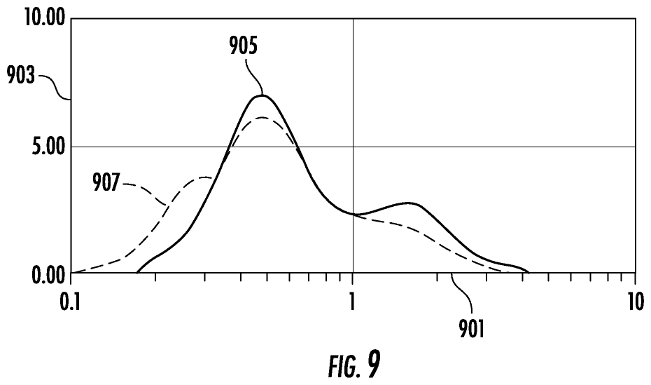

Milling in step 105 can reduce a variability in particle size of the materials in the precursor mixture and/or increase a uniformity of the distribution of the materials in the precursor mixture. For example, FIG. 8 shows particle size distributions 805 and 807 with a horizontal axis 801 corresponding to particle size in μm and a vertical axis 803 corresponding to a frequency of a corresponding particle size. Distributions 805 and 807 were measured using a laser diffraction method; however, similar (or the same) distributions are expected if the distributions were measured using SEM. Distribution 805 represents the initial particle size distribution of the source materials as combined to form the precursor mixture without mixing or milling while distribution 807 is the precursor mixture after turbula mixing for 10 minutes and then attrition milling with 2 mm zirconia beads as a milling media and 60 wt % water (of the initial precursor mixture) for 2 hours at 2,000 revolutions per minute (rpm). As shown, the larger particle sizes (e.g., about 5 mm or more) have been converted to smaller particle sizes.

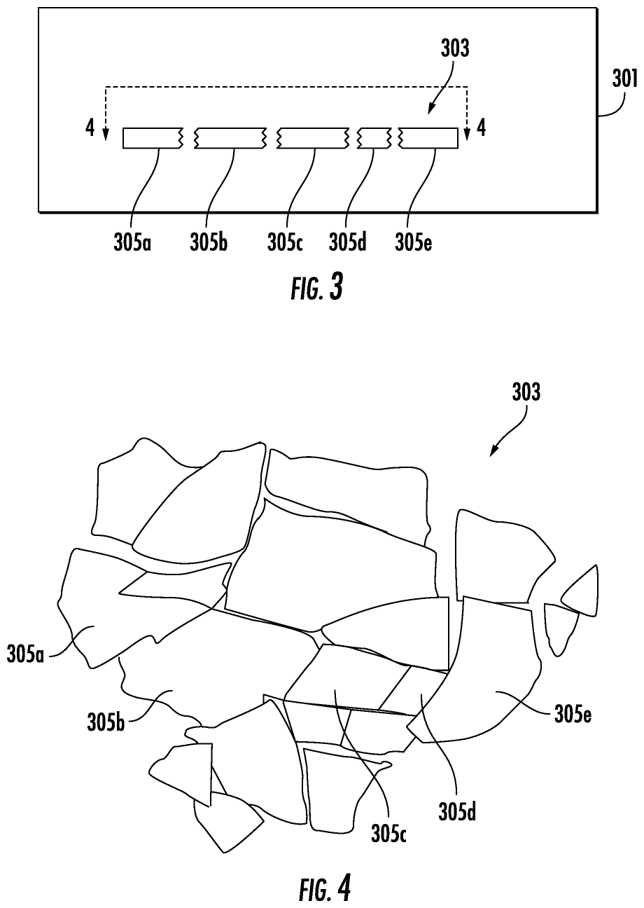

After step 101 or 105, as shown in FIG. 3, methods can proceed to step 107 comprising drying the slurry to form a solid precursor 303. In aspects, as shown in FIG. 3, drying the slurry can comprise placing the slurry in an oven 301 maintained at a first temperature for a first period of time to form the solid precursor 303. In aspects, the first temperature can be about 30 °C or more, about 50 °C or more, about 80 °C or more, about 100 °C or more, about 250 °C or less, bout 200 °C or less, about 170 °C or less, or about 150 °C or less. In aspects, the first temperature can range from about 30 °C to about 250 °C, from about 50 °C to about 200 °C, from about 80 °C to about 170 °C, from about 100 °C to about 150 °C, or any range or subrange therebetween. In aspects, the first period of time can be about 10 minutes or more, about 20 minutes or more, about 30 minutes or more, about 24 hours or less, about 8 hours or less, or about 2 hours or less. In aspects, the first period of time can range from about 10 minutes to about 24 hours, from about 20 minutes to about 8 hours, from about 30 minutes to about 2 hours, or any range or subrange therebetween. Alternatively, in aspects, the drying the slurry in step 107 can comprise spray drying. In aspects, as shown in FIGS. 3-4, the solid precursor 303 can comprise a precursor cake that can comprise a plurality of naturally formed chunks 305a-305e. As used herein, a “naturally formed chunk” occurs as a result of the drying in step 107 without direct physical contact. The naturally formed chunks can be physically stable such that they can be handled without disintegrating. Without wishing to be bound by theory, it is believed that the plurality of naturally formed chunks maintains the uniform distribution of source materials from the slurry, which enables the calcining to occur quickly, as compared to powders or non-physically stable materials that do not maintain the uniform distribution of source materials.

In aspects, prior to the drying, step 107 can further comprise adding additional solvent, for example, to remove any milling material present during step 105. In further aspects, an amount of the additional solvent can be within one or more of the ranges mentioned above for the amount of solvent added in step 105. In even further aspects, the additional solvent can be the same material as the solvent. In even further aspects, the amount of the additional solvent can be the same as or greater than the amount of solvent added in step 105.

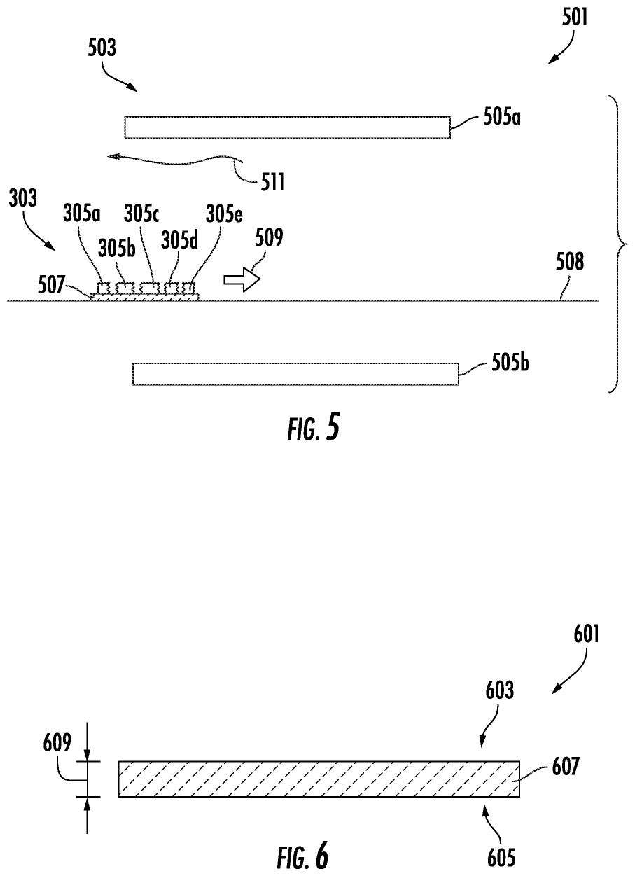

After step 107, as shown in FIG. 5, methods can proceed to step 109 comprising calcining the solid precursor at a calcining temperature to form a precursor mixture. In aspects, as shown in FIG. 5, the solid precursor 303 can be heated by an oven 503 (e.g., one or more heaters 505a and 505b) at the calcining temperature for a calcining period of time. In aspects, the calcining temperature can be about 900 °C or more, about 950 °C or more, about 1000 °C or more, about 1200 °C or less, about 1100 °C or less, or about 1050 °C or less, for example, in a range from about 900 °C to about 1200 °C, from about 950 °C to about 1100 °C, from about 1000 °C to about 1050 °C, or any range or subrange therebetween. In aspects, the calcining period of time can be about 2 minutes or more, about 4 minutes or more, about 6 minutes or more, about 8 minutes or more, about 40 minutes or less, about 30 minutes or less, about 20 minutes or less, about 16 minutes or less, or about 12 minutes or less. In aspects, the calcining period of time can range from about 2 minutes to about 40 minutes, from about 4 minutes to about 30 minutes, from about 4 minutes to about 20 minutes, from about 4 minutes to about 16 minutes, from about 4 minutes to about 12 minutes, or any range or subrange therebetween. As used herein, the calcining period of time refers to the time that the environment surrounding the solid precursor is within one or more of the ranges mentioned above for the calcining temperature.

In aspects, as shown in FIG. 5, a heating apparatus 501 can be used to convey (as indicated by arrow 509) the solid precursor 303 into the oven 503, for example, along a conveyance path 508. In further aspects, the solid precursor 303 can go from an environment at about room temperature (e.g., from about 20 °C to about 30 °C) to an environment at the calcining temperature (e.g., within one or more of the ranges mentioned above for the calcining temperature) in a second period of time. In even further aspects, the second period of time can be about 1 minute or more, about 2 minutes or more, about 3 minutes or more, about 8 minutes or less, about 6 minutes or less, about 5 minutes or less, or about 4 minutes or less, for example, from about 1 minute to about 8 minutes, from about 2 minutes to about 8 minutes, from about 3 minutes to about 6 minutes, or any range or subrange therebetween. In aspects, after the heating at the calcining temperature, the lithium garnet (created from calcining the solid precursor) can be transferred from an environment at the calcining temperature to about room temperature in a third period of time, which can be within one or more of the ranges discussed above for the second period of time.

In aspects, as shown in FIG. 5, a gas can be flowed over the solid precursor 303 during step 109 (as indicated by arrow 511). In further aspects, as shown, the gas can be flowed opposite the direction that the solid precursor is conveyed. In further aspects, the gas can be a non-reactive gas, for example, nitrogen, argon, krypton, or combinations thereof. Without wishing to be bound by theory, providing the gas flow can increase the removal of any residual solvent and/or gases volatilized during the calcining, which can enable the calcining to be completed faster than would otherwise be possible. In aspects, as shown in FIG. 5, the solid precursor 303 can be placed on a conveyance 507 including a surface that may not react with the lithium source during the calcining in step 109. The surface that does not react with the lithium source can be platinum, carbon, or iridium. An exemplary aspect of a surface that does not react with the lithium source is iridium. Providing a surface that does not react with the lithium source can enable the lithium garnet to be formed without excess lithium relative to the resulting stoichiometric ratio.

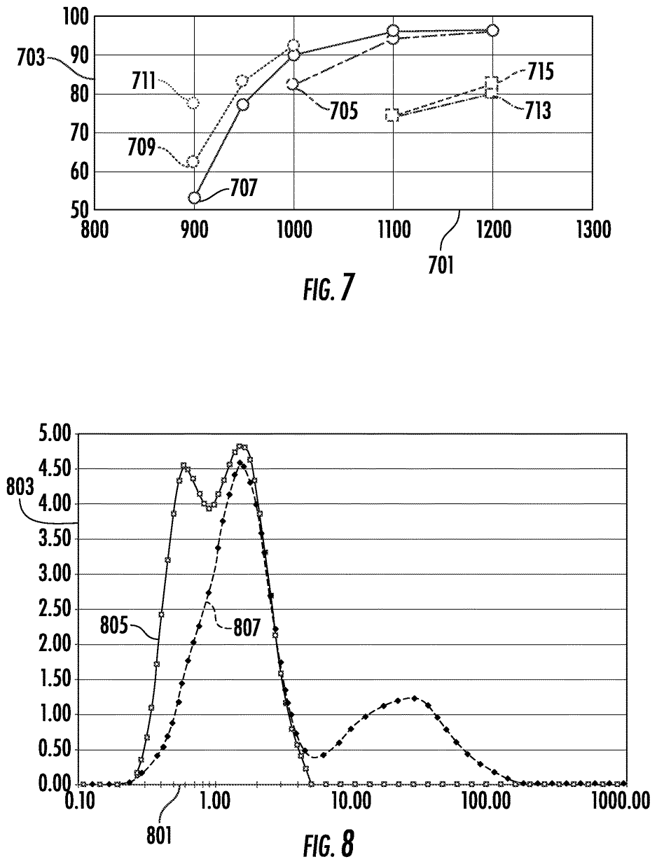

As discussed below with reference to FIG. 7, it is unexpected that 80% or more or 90% or more of a volume of the resulting lithium garnet (e.g., at the end of step 109) can be in a cubic phase with a calcining step at a temperature from about 900 °C to about 1200 °C for 40 minutes or less (e.g., within one or more of the ranges mentioned above in this paragraph). Without wishing to be bound by theory, the cubic phase of lithium garnet has a higher ionic conductivity than the tetragonal phase of lithium garnet. Throughout the disclosure, the amount of cubic phase lithium garnet is determined using X-ray diffraction (XRD). In aspects, at the end of step 109, a percentage of a volume of the resulting lithium garnet in the cubic phase can be about 80% or more, about 85% or more, about 88% or more, about 90% or more, about 92% or more, 98% or less, about 95% or less, about 94% or less, or about 93% or less. In aspects, at the end of step 109, a percentage of a volume of the resulting lithium garnet in the cubic phase can range from about 80% to about 98%, from about 80% to about 95%, from about 85% to about 94%, from about 88% to about 94%, from about 90% to about 93%, from about 92% to about 93%, or any range or subrange therebetween.

After step 109, methods can proceed to step 111 comprising further processing the lithium garnet. The lithium garnet can be milled to achieve a predetermined particle size. For example, the lithium garnet can comprise a median particle size of about 2 μm or less, about 1 μm or less, about 0.8 μm or less, or about 0.6 μm or less. The lithium garnet can also be formed into a ceramic green-body, for example, by casting a mixture comprising the lithium garnet, a binder, and a solvent. The ceramic green-body can then be sintered to form the sintered sheet (e.g., see FIG. 6), which can be assembled into a composite article, for example, a battery (e.g., solid-state battery). In aspects, the sintered sheet can be an electrode (e.g., cathode) and/or a solid-state electrode in a battery. In aspects, the sintered sheet can be incorporated into a consumer electronic device (e.g., a display device), for example, as a protective cover.

After step 109 or 111, methods can be complete upon reaching step 113. In aspects, methods of making lithium garnet (e.g., sintered sheet comprising lithium garnet) in accordance with aspects of the disclosure can proceed along steps 101, 103, 105, 107, 109, 111, and 113 of the flow chart in FIG. 1 sequentially, as discussed above. In aspects, methods can follow arrow 102 from step 101 to step 109, for example, if a solid precursor is already present at the end of step 101. In aspects, methods can follow arrow 104 from step 109 to step 113, for example, if methods are complete at the end of step 109. Any of the above options may be combined to make a sintered article or ceramic green-body in accordance with the embodiments of the disclosure.

### Examples

Various aspects will be further clarified by the following examples. Table 1 shows the composition of Examples A-F. All of the Examples and Comparative Examples were configured to make Li_{6.5}La₃Zr_{1.5}Ta_{0.5}O₁₂, where Ta is the optional dopant. Examples A-F comprised the source materials in the stoichiometric ratio corresponding to Li_{6.5}La₃Zr_{1.5}Ta_{0.5}O₁₂. The “mol % source” refers to the mol % of the source element from each material, for example, Li₂CO₃ has twice the moles of Li as overall moles of Li₂CO₃ while ZrO₂ has the same number of moles of Zr as moles of ZrO₂. As shown, the mol % source (excluding the seed crystal) is the same for Examples A-D and Examples E-F. The only difference in the composition of Examples A-D compared to Examples E-F is that Examples A-D have 0.5 wt % seed crystal while Examples E-F did not have any seed crystal.

TABLE 1
Composition of Examples A-F

| | | Examples | | Examples |
|---|---|---|---|---|
| Source | Examples | A-D (mol % | Examples | E-F (mol % |
| Material | A-D (wt %) | source) | E-F (wt %) | source) |
| Li₂CO₃ | 23.3 | 56.5 | 23.4 | 56.5 |
| La₂O₃ | 47.4 | 26.1 | 47.7 | 26.1 |
| ZrO₂ | 18.0 | 13.0 | 18.1 | 13.0 |
| Ta₂O₅ | 10.8 | 4.4 | 10.8 | 4.4 |
| Seed | 0.5 | — | 0 | — |
| Crystal | | | | |

For Examples A-D, the source materials (including the seed crystal) were combined and mixed using a turbula mixer for 10 minutes to form the precursor mixture. Then, 2 mm zirconia beads (300 wt % of the precursor mixture) were added along with water as a solvent (60 wt % of the precursor mixture) and this combination was attrition milled at 2000 rpm for 2 hours to form the slurry. More water (an additional 60 wt % of the precursor mixture) was added and the milling media was removed from the slurry before the resulting slurry was dried at 120 °C for 1 hour to form the solid precursor as a precursor cake. As shown in FIG. 4, the solid precursor 303 is a precursor cake that separated into a plurality of naturally formed chunks 305a-305e. These naturally formed chunks of the solid precursor (e.g., precursor cake) were placed in a platinum boat and conveyed through a tube furnace maintained at the calcining temperature to form the lithium garnet. Table 2 provides the time that the corresponding Example was heated at the calcining temperature, which was set from 900 °C to 1200 °C, as indicated in Table 2 and FIG. 7 with the calcining temperature held constant for a corresponding sample. During the calcining, the environment of the tube furnace was argon gas, and argon gas was circulated through the tube furnace in a direction opposite a direction that the solid precursor (e.g., precursor cake) was conveyed. Examples E-F were treated in the same manner as Examples A-D with the only difference being the absence of the seed crystal in Examples E-F.

TABLE 2
% Cubic Phase Lithium Garnet

| Calcine | Ex. A | Ex. B | Ex. C | Ex. D | Ex. E | Ex. F |
|---|---|---|---|---|---|---|
| Temperature | (4 | (8 | (12 | (16 | (4 | (8 |
| (°C) | min) | min) | min) | min) | min) | min) |
| 900 °C | — | 52 | 62 | 78 | — | — |
| 950 °C | — | 78 | 84 | — | — | — |
| 1000 °C | 82 | 90 | 92 | — | — | — |
| 1100 °C | 92 | 95 | — | — | 75 | 75 |
| 1200 °C | 94 | 94 | — | — | 80 | 82 |

FIG. 7 shows the results also presented in Table 2. In FIG. 7, the horizontal axis 701 corresponds to the calcining temperature in °C, and the vertical axis 703 corresponds to the volume percent of the lithium garnet in the cubic phase after the calcining. Curves 705, 707, 709, 711, 713, and 715 correspond to Examples A-F, respectively. For curve 705 (Example A), 80% or more cubic phase is obtained after just 4 minutes of heating at a calcining temperature of about 1000 °C or more. For curves 707 and 709 (Examples B-C), 90% or more cubic phase is obtained for 8 minutes and 12 minutes, respectively, of heating at a calcining temperature of about 1000 °C or more. Since the percentage in the cubic phase increases with calcining temperature in Table 2 and FIG. 7, a calcining temperature of more than 900° (e.g., about 950 °C or more, about 1000 °C or more) is expected to produce more than 80% cubic phase. Likewise, the percentage in the cubic phase increases with calcining time (at the calcining temperature); so, it is expected that heating at a calcining temperature of about 900 °C or more will produce 80% or more cubic phase for calcining times greater than 16 minutes (e.g., from about 20 minutes to about 40 minutes, from about 20 minutes to about 30 minutes).

Curves 713 and 715 (Examples E-F) exhibit 80% or more cubic phase for a calcining temperature of about 1200 °C. Comparing curves 705, 707, 709, and 711 (Examples A-D) to curves 713 and 715 (Examples E-F), the presence of the seed crystal in Examples A-D increases the amount of cubic phase obtained at a corresponding treatment (e.g., calcining time and calcining temperature). Also, the presence of the seed crystal decreases the calcining time and/or calcining time needed to obtain a predetermined amount of the cubic phase.

For Examples A-F, the samples were conveyed at a constant rate through the tube furnace. Consequently, the time for the environment to go from room temperature to the calcining temperature scaled linearly with the calcining time. For example, it took 2 minutes for the environment around Examples A and E to go from room temperature to the calcining temperature while it took 4 minutes for Examples B and F. The same relationship held for the decrease in the temperature of the environment as the samples were conveyed out of the tube furnace.

As discussed above, FIG. 8 shows that milling the precursor materials in the solvent decreases the median particle size (comparing curve 805 to curve 807). FIG. 9 shows particle size distributions of lithium garnet that was milled after being calcined. In FIG. 9, the horizontal axis 901 corresponds to the particle size in μm, and the vertical axis 903 corresponds to a frequency of a corresponding particle size. Curve 905 represents the particle size distribution of Example A calcined at 1100 °C for 4 minutes that was then jet milled at 100 grams per hour (g/h) and 0.9 MegaPascals. Curve 907 represents the particle size distribution after the lithium garnet corresponding to curve 905 was subjected to a second jet milling at the same conditions. The median particle size for curve 905 is 0.55 μm, and the median particle size for curve 907 is 0.48 μm. Comparing curves 905 and 907, the additional jet milling decreased the fraction of particles greater than 1 μm and increased the fraction of particles smaller than 0.3 μm.

The above observations can be combined to provide lithium garnet that can be made by calcining for about 40 minutes or less. Compared to traditional methods that can require a day or more of calcining, the methods of the present disclosure represent an unexpected and substantial reduction in processing time and associated costs. As discussed above with reference to FIG. 7, it is unexpected that 80% or more or 90% or more of a volume of the resulting lithium can be in a cubic phase with a calcining step at a temperature from about 900 °C to about 1200 °C for 40 minutes or less (e.g., within one or more of the ranges mentioned above in this paragraph). Without wishing to be bound by theory, the cubic phase of lithium garnet has a higher ionic conductivity than the tetragonal phase of lithium garnet.

Methods include forming slurry from a precursor mixture that can be dried to form a solid precursor, for example, a precursor cake that can comprise a plurality of naturally formed chunks. The naturally formed chunks can be physically stable such that they can be handled without disintegrating. Without wishing to be bound by theory, it is believed that the plurality of naturally formed chunks maintains a uniform distribution of source materials from the slurry, which enables the calcining to occur quickly, as compared to powders or non-physically stable materials that do not maintain the uniform distribution of source materials. In aspects, the lanthanum source can comprise lanthanum oxide that can react with the solvent (e.g., water) to form lanthanum hydroxide in step 105. The reaction from lanthanum oxide to lanthanum hydroxide can cause the lanthanum source to break into smaller particles, which decreases the overall particle size distribution of materials in the slurry.

During the calcining, a flow of a non-reactive gas can be provided and/or the solid precursor (e.g., precursor cake) can be placed on a surface that does not react with the lithium source. Without wishing to be bound by theory, providing the gas flow can increase the removal of any residual solvent and/or gases volatilized during the calcining, which can enable the calcining to be completed faster than would otherwise be possible. Providing a surface that does not react with the lithium source can enable the lithium garnet to be formed without excess lithium relative to the resulting stoichiometric ratio.

Directional terms as used herein—for example, up, down, right, left, front, back, top, bottom—are made only with reference to the figures as drawn and are not intended to imply absolute orientation.

It will be appreciated that the various disclosed aspects may involve features, elements, or steps that are described in connection with that aspect. It will also be appreciated that a feature, element, or step, although described in relation to one aspect, may be interchanged or combined with alternate aspects in various non-illustrated combinations or permutations.

It is also to be understood that, as used herein the terms “the,” “a,” or “an,” mean “at least one,” and should not be limited to “only one” unless explicitly indicated to the contrary. For example, reference to “a component” comprises aspects having two or more such components unless the context clearly indicates otherwise. Likewise, a “plurality” is intended to denote “more than one.”

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. Ranges can be expressed herein as from “about” one particular value, and/or to “about” another particular value. When such a range is expressed, aspects include from the one particular value and/or to the other particular value. Similarly, when values are expressed as approximations, by use of the antecedent “about,” it will be understood that the particular value forms another aspect. Whether or not a numerical value or endpoint of a range in the specification recites “about,” the numerical value or endpoint of a range is intended to include two aspects: one modified by “about,” and one not modified by “about.” It will be further understood that the endpoints of each of the ranges are significant both in relation to the other endpoint and independently of the other endpoint.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, as defined above, “substantially similar” is intended to denote that two values are equal or approximately equal. In aspects, “substantially similar” may denote values within about 10% of each other, for example, within about 5% of each other, or within about 2% of each other.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred.

While various features, elements, or steps of particular aspects may be disclosed using the transitional phrase “comprising,” it is to be understood that alternative aspects, including those that may be described using the transitional phrases “consisting of” or “consisting essentially of,” are implied. Thus, for example, implied alternative aspects to an apparatus that comprises A+B+C include aspects where an apparatus consists of A+B+C and aspects where an apparatus consists essentially of A+B+C. As used herein, the terms “comprising” and “including”, and variations thereof shall be construed as synonymous and open-ended unless otherwise indicated.

The above aspects, and the features of those aspects, are exemplary and can be provided alone or in any combination with any one or more features of other aspects provided herein without departing from the scope of the disclosure.

It will be apparent to those skilled in the art that various modifications and variations can be made to the present disclosure without departing from the spirit and scope of the disclosure. Thus, it is intended that the present disclosure cover the modifications and variations of the aspects herein provided they come within the scope of the appended claims and their equivalents.

What is claimed is:

1. A method of making lithium garnet comprising:
combining a lithium source, a lanthanum source, a zirconium source, an optional dopant, and an optional lithium garnet seed crystal to form a precursor mixture;
mixing the precursor mixture with a solvent to form a slurry;
drying the slurry to form a solid precursor; and
calcining the solid precursor at a calcining temperature from about 900 °C to about 1200 °C for a period of time from about 2 minutes to about 40 minutes to form the lithium garnet.

2. The method of claim 1, wherein one or none of the materials in the precursor mixture has a solubility in the solvent of 15 grams per liter or more.

3. The method of claim 1, wherein one or both of the lithium source or the zirconium source do not react prior to the calcining.

4. The method of claim 1, wherein the precursor mixture comprises the lithium garnet seed crystal in an amount from about 0.1 wt % to about 1 wt % of the precursor mixture.

5. The method of claim 1, wherein the precursor mixture is stoichiometric to a composition of the lithium garnet.

6. The method of claim 1, wherein the lithium garnet comprises a composition comprising:
(i) Li₇₋₃ₐLa₃Zr₂LₐO₁₂, with L=Al, Ga, or Fe and 0<a<0.33;
(ii) Li₇La_{3-b}Zr₂M_{b}O₁₂, with M=Bi or Y and 0<b<1;
(iii) Li_{7-c}La₃(Zr_{2-c},N_{c})O₁₂, with N=In, Si, Ge, Sn, V, W, Te, Nb, or Ta and 0<c<1;
(iv) protonated LLZO (e.g., HₓLi_{6.5-x}La₃Zr_{1.5}I_{0.5}O₁₂, with I=In, Si, Ge, Sn, V, W, Te, Nb, or Ta and 0<x<4 or HₓLi_{6.25-x}E_{0.25}La₃Zr₂O₁₂, with E=Al, Ga, or Fe and 0<x<4); or
a combination thereof,
wherein the optional dopant comprises L, M, N, I, or E.

7. The method of claim 1, wherein from about 80% to about 95% of a volume of the lithium garnet comprises a cubic phase.

8. The method claim 1, wherein 90% or more of a volume of the lithium garnet comprising a cubic phase.

9. The method of claim 1, wherein the mixing comprises milling the precursor mixture with the solvent for about 90 minutes or more.

10. The method of claim 1, wherein the drying comprises heating the slurry at from about 100 °C to about 150 °C for from about 30 minutes to about 2 hours.

11. The method of claim 1, wherein the solid precursor comprises a precursor cake comprising a plurality of naturally formed chunks.

12. The method of claim 1, wherein the period of time is from about 4 minutes to about 30 minutes.

13. The method of claim 1, wherein the solid precursor is heated at a temperature increasing from an initial temperature from about 20 °C to about 30 °C to the calcining temperature over a second period of time from about 2 minutes to about 15 minutes.

14. The method of claim 1, wherein the calcining further comprising flowing a non-reactive gas over the solid precursor.

15. The method of claim 1, wherein the solvent comprises water.

16. The method of claim 1, wherein the lanthanum source is lanthanum oxide, and during the mixing, at least a portion of the lanthanum oxide forms lanthanum hydroxide.

17. The method of claim 1, wherein:
the precursor mixture consisting of the lithium source, the lanthanum source, the zirconium source, the optional dopant, and the lithium garnet seed crystal; and
the slurry consists of the solvent, the lithium source, the zirconium source, the optional dopant, the lithium garnet seed crystal, and either the lanthanum source or lanthanum hydroxide.

18. The method of claim 1, wherein the lithium source comprises lithium carbonate, and the zirconium source comprises zirconia.

19. The method of claim 1, wherein the solid precursor is placed on a surface that does not react with the lithium source during the calcining.

20. The method of claim 1, wherein the calcining temperature is in a range from about 950 °C to about 1100 °C.
